(19) United States
(12) Patent Application Publication
(10) Pub. No.: US 2002/0155348 A1
(43) Pub. Date: Oct. 24, 2002

(54) Flame-retardant battery casing

(75) Inventor: Gary C. Gitto, Leominster, MA (US)

Correspondence Address: THOMAS O. HOOVER, ESQ., BOWDITCH & DEWEY, LLP, 161 Worcester Road, P.O. Box 9320, Framingham, MA, 01701-9320, US

(73) Assignee: GITTO/GLOBAL CORPORATION, Lunenburg, MA (US)

(21) Appl. No.: 09/911,259

(22) Filed: Jul. 23, 2001

Related U.S. Application Data
(63) Continuation of application No. 08/891,764, filed on Jul. 14, 1997, now abandoned.
Application No. 08/891,764 is a division of application No. 08/654,232, filed on May 28, 1996, now abandoned.

(51) Int. Cl. H01M 2/02

(52) U.S. Cl. 429/163; 429/176; 523/134; 429/185

(57) ABSTRACT

A battery casing is formed of a flame-retardant thermoplastic composition that includes a blend of a homopolymer, copolymer and ammonium polyphosphate. The ammonium polyphosphate is in an amount to impart flame-retardance to the thermoplastic composition. Other components include polyol, intumescent char-forming agent, and melamine, which acts as a blowing agent. Antioxidants, release agents, carbon black, reinforcers and other additives can be included. Alternatively, the battery casing includes a polymer composition with a halogen-containing fire-retardant component and a polypropylene component.

### RELATED APPLICATIONS

This is a continuation application of U.S. application Ser. No.: 08/891,764 filed on Jul. 14, 1997 which is a divisional application of U.S. application Ser. No.: 08/654,232 filed on May 28, 1996, the entire teachings of the above applications are incorporated herein by reference.

### BACKGROUND OF THE INVENTION

Battery casings are typically formed of plastic. These battery casings can be used in batteries that are used in phone systems, computers, electrically-powered vehicles, etc. However, many battery casings generally are also highly flammable. They can generate dense, toxic and corrosive smoke when burning, and rapidly lose their mechanical strength under the effect of heat and propagate fire through dripping. These are potential hazards that can be of particular significance in the use of batteries for phone systems, computers and electrically-powered vehicles, for example.

Various techniques have been developed to impart flame retardancy or fire resistancy to plastics. Fire-resistant properties can be imparted to plastic materials by mixing polymer components with one or more fire retardants. Examples of fire retardants include halogenated compounds having a high content of halogen. Other examples include phosphorus compounds, such as derivatives of phosphoric acid and polyphosphoric acid, and agents formed of metal derivatives, such as hydrated alumina, magnesium hydroxide, etc.

However, fire retardants typically undermine the physical and mechanical properties of the plastic materials due to the presence of the fire-resistant or flame-retardant agent or system. Another disadvantage is that plastics containing halogenated organic compounds can generate dense and toxic smoke upon exposure to fire, such as hydrogen chloride (HCl). Also many non-halogenated flame retardants exhibit hydroscopic behavior, thereby making molding of plastic parts difficult.

Therefore, a need exists for fire-resistant and flame retardant plastic compositions that have improved mechanical properties suitable for forming a battery casing.

### SUMMARY OF THE INVENTION

The present invention relates to a flame-retardant battery casing, flame-retardant composition for forming battery casings, and a method for forming a battery casing of the composition. In a preferred embodiment, a flame-retardant component of the composition is non-halogenated.

The batteries employing the casings of the present invention are typically one to two volts per cell, must meet standards for durability and strength, contain toxic or hazardous materials, and because they are used as backup electrical systems during and after fires or floods, must be sealed relative to their environment. Each casing typically includes a ribbed unitary molded base section having a bottom and four walls. The battery housing also includes a top or cover having openings in which terminals for external electrical connections are secured. In a preferred embodiment, additional openings in the cover are fitted with resealable caps to permit periodic maintenance. The casing can be molded to include separate chambers or compartments. The batteries can be stacked on each other or on a rack system and electrically connected to provide backup power using a switching system that brings backup power on automatically when the main power is interrupted. This maintains the computer or communications system, for example, without loss of operation or data.

The battery casing is formed of a flame-retardant thermoplastic composition which includes a homopolymer, copolymer and ammonium polyphosphate. One of the advantages of the invention includes a polymer composition that has flame-retardant and fire-resistant characteristics for battery casings while maintaining structural integrity of the batteries. Battery casings of the invention, which are formed of a non-halogenated flame retardant have improved rigidity and flexural modulus.

The flame retardant thermoplastic composition for formation of the battery casing includes a homopolymer, a copolymer and ammonium polyphosphate wherein the homopolymer, copolymer and ammonium polyphosphate are blended. The ammonium polyphosphate is present in an amount sufficient to impart significant flame retardance to the thermoplastic composition. The composition can employ a flame retardant that is less hygroscopic and, therefore, provides more flexibility in a method of blending polymer composition components.

The method includes blending a homopolymer, copolymer, and ammonium polyphosphate at a temperature in a range of between about 340 and 410 F. to form the flame-retardant composition. The composition can blend at a lower temperature, can be employed to mold larger parts, such as battery casings by injection molding, and can be cooled after blending by alternative methods, such as by cooling with air instead of water.

### BRIEF DESCRIPTION OF THE DRAWINGS

FIG. 1 is a schematic flow chart of a system for forming the fire-retardant composition.

FIG. 2 is a cross-sectional view of a Farrell-type continuous mixer.

FIG. 3 is a cross-sectional view of a Farrell-type continuous mixer and an extruder.

FIG. 3A is an end view of the Farrell-type continuous mixer shown in FIG. 3.

FIG. 4 is an isometric projection of one embodiment of a partially constructed battery casing of the present invention.

FIG. 5 is an isometric projection of one embodiment of a constructed battery casing of the present invention.

FIG. 6 is an isometric projection of a second embodiment of the constructed battery casing of the present invention.

FIG. 7 is an isometric projection of a third embodiment of the constructed battery casing of the present invention.

FIG. 8 is an isometric projection of a fourth embodiment of the constructed battery casing of the present invention.

FIG. 9 is a schematic diagram of a system powered by a main power supply with a backup power supply.

### DETAILED DESCRIPTION OF THE INVENTION

The features and other details of the method and apparatus of the invention will now be more particularly described with reference to the accompanying drawings and pointed out in the claims. It will be understood that the particular embodiments of the invention are shown by way of illustration and not as limitations of the invention. The principal features of this invention can be employed in various embodiments without departing from the scope of the invention. All parts and percentages are by weight unless otherwise specified.

This invention relates to a battery casing formed of fire-resistant thermoplastic composition and a method for forming the battery casing with a low smoke, low corrosive, flame retardant polymer composition. The composition, therefore, can be processed by methods conventionally and in the processing of thermoplastic resins.

The term plastic material used herein refers to thermoplastic polymeric material, to thermoset polymeric material as well as to polymeric rigid foam and semi-flexible foam material. The term plastic article refers to an article the core of which is made from said plastic material.

Fire resistance and flame retardance are used herein interchangeably to refer to materials which have been used in connection with or treated or modified by means of certain chemical compounds or mixtures of compounds (systems) to show reduced combustion rate compared to the corresponding non-treated or non-modified materials. Similarly, a flame-retardant or fire-resistant agent or system refers to a chemical compound or mixture of compounds which imparts to the material a reduced combustion rate compared to the corresponding non-treated or non-modified material.

One embodiment of the composition can be described as a non-halogen, low smoke, low corrosive, flame retardant but yet the overall performance is superior to halogenated compositions for battery case applications. The compositions of the present invention may generally be utilized for a wide array of products. The amount of the various components can be varied to achieve an exact combination of physical, electrical and combustion properties for a particular application. In another embodiment, a halogen-containing material can be included in thermoplastic composition such as the halogen flame retardant disclosed in U.S. Pat. No. 5,356,568, the teachings of which are incorporated herein by reference.

In battery case applications, it is important that the material be able to withstand impact and have higher flexural modules. The composition generally exhibits these properties when amounts of the various components are set forth.

Commercially available thermoplastic polyolefin resins, such as polyethylene or polypropylene, can be used including linear low density polyethylene. Polypropylene is the preferred polyolefin, having highly crystalline isotactic and syndiotactic forms. Crystalline block copolymers of ethylene and propylene, which are plastics distinguished from amorphous, random ethylene-propylene elastomers, can also be used. Included among the polyolefin resins are the higher alpha-olefin modified polyethylenes and polypropylenes. Other thermoplastic compositions can include a crystalline, high molecular weight solid product formed by the polymerization of one or more polyolefins selected from the group consisting of ethylene, propylene, 1-butene, 1-hexene, 2-methyl-1-propene, 3-methyl-l-pentene, 4-methyl-1-pentene and 5-methyl-1-hexene. In one preferred embodiment, a co-polymer has a melt flow resin value of 12 and a homopolymer has a melt flow resin value of 4.

Phosphorous flame retardants are classified by the way they interact with materials that are subject to ignition. Phosphorous compounds can be separated into four classes based on the number of phosphorous-oxygen and phosphorous-carbon bonds: phosphate, phosphonate, phosphinate and phosphine oxide. The two that are flame retardants are the phosphates and phosphonates. Condensed phase includes a reaction that affects the burning characteristics of the polymer. Nonvolatile acids are dehydration catalysts. These catalysts are the char producers. Vapor phase is described as forming phosphorous oxides which act as free radical scavengers and inhibits ignition by depleting the hydrogens in the fire.

A preferred halogen-free, flame-retardant system based on ammonium polyphosphate is Hostaflam TP AP 750 system, available from Hoechst Chemicals. Unlike chlorinated or brominated flame retardants, the Hostaflam TP AP 750 flame-retardant system forms a carbonaceous foam with the thermoplastic material as a result of intumescent action which serves as an insulative barrier, reduces the access of oxygen and prevents the polymer from dripping. A preferred flame-retardant system includes a very high phosphoric acid amount with a neutral pH in an aqueous system. The system includes at least fifteen percent phosphorous. In a preferred embodiment, the Hostaflam TP AP 750 in the battery casing thermoplastic composition is present in an amount of about 28.5 percent by weight.

Fillers, such as aluminum trihydrate, hydrated magnesium, or hydrated calcium silicate, can also be included in the composition. Other fillers which can be used include those commonly used in plastic compounding, such as clays, talcs, carbonates, carbon black, hydrates and oxides. In a preferred embodiment, clay is used.

The processability of the present blends can be evaluated by subjecting samples of the blend to such shaping operations as injection molding or compression molding. For satisfactory injection molding, the material must form in the mold a homogeneous article of uniform strength. The flow viscosity characteristics of such blends are adequate to insure filling the mold properly under the operating conditions. In processing the inventive blend, it is advantageous to include a lubricant, particularly from the standpoint of improving the molding quality of the blend composition. In a preferred embodiment, the lubricant is selected from the group consisting of Akzo Armeen 18D and Vanfre from Vam. For this purpose, any known lubricant conventionally used in plastics processing can be used, generally in amounts varying from about 0.1-3 parts by weight per 100 parts of the resin blend. In a preferred embodiment, about 0.5-1 part by weight per 100 parts of the resin blend can be used.

In processing the resin blend, it has been found that the use for a three component stabilizer system is suitable for obtaining a desirable product. The first component of the stabilizer system includes a high molecular weight multi-functional sterically hindered phenol, such as tetrakis-(methylene 3-(3′,5′-distert butyl-4′-hydroxyphenyl) propionate methane), more simply referred to as “tetrakis methane”, available from Ciba Geigy Corporation under the trademark Iryanox 1010. The high molecular weight multifunctional sterically hindered phenol functions as an antioxidant and thermal stabilizer.

The second component of the stabilizer system is an alkali ester of a thiodipropionic acid such as diauryl thiodipropionate which functions as a second antioxidant.

The third component of the stabilizer system is a substituted benzotriazole, such as 2-(3′,5′-di-tert-butyl-2′hydroxyphenyl)-5-chlorobenzotriazole available under the trademark Tinuvin 327 from Ciba Geigy Corporation and functions in the stabilizer system to protect the polymeric blend against ultraviolet radiation.

The amount of stabilizer system can vary from about 0.5-10 parts by weight, and preferably about 1-3 parts by weight of the thermoplastic composition.

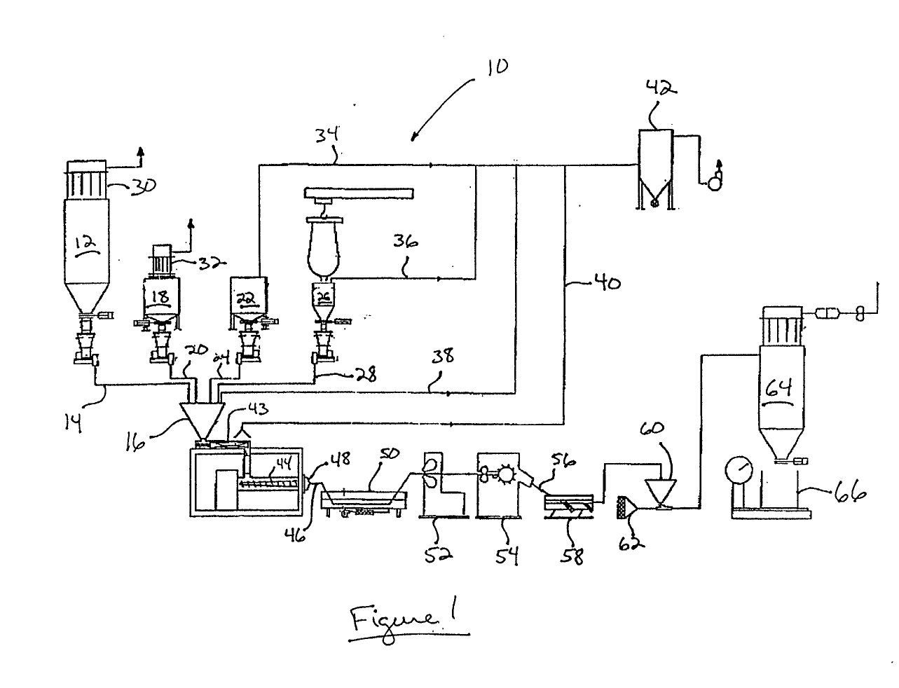

The thermoplastic blend of the present invention can be manufactured in a single operation, or in a number of operational steps. FIG. 1 shows a schematic flow diagram of an apparatus for forming the flame-retardant thermoplastic composition. In system 10, homopolymer is directed from first holding bin 12 through line 14 to converging chute 16. Copolymer is directed from second holding bin 18 through line 20 to converging chute 16. Suitable pigments and additives are directed from third holding bin 22 through line 24 to converging chute 16. Fillers are directed from filler holding bin 26 through line 28 to converging chute 16. Excess homopolymer dust can be removed from first holding bin 12 through first filter 30 and vents air to atmosphere. Excess copolymer dust can be removed from second holding bin 18 through second filter 32 and vents air to atmosphere. Dust from fillers, pigments, additives and the materials in converging chute 16 are removed through dust lines 34,36,38,40 to dust collector 42, where the air is filtered and vented to the atmosphere.

In the single step operation, the polyolefin resins, flame-retardant system, filler and other additions are charged at the desired ratio to a Farrell Continuous Mixer (FCM), transfer type extruder-mixer that allows efficient mastication of the blend at the desired temperature. The blending apparatus can be pretreated to reduce the time necessary to reach the processing temperature range. The same operation can also be run in a Banbury-type mixer.

The blend is then held at the processing temperature while continuing the mixing. During processing, the stabilizer system is contacted with the blend and processing is continued for a short time, usually for about one minute or more in order to thoroughly incorporate the stabilizer in the blend.

In the multi-step process, the polyolefin resin and flame retardant are charged to a suitable apparatus wherein flame retardant masterbatching takes place. Thereafter, the flame retardant masterbatch is blended with the polyolefin resin at desirable ratios and with other components as needed.

From converging chute 16, the components are blended and heated to a temperature of between about 340° F.(171° C.) and 410° F. (210° C.) in mixer 43. Flame-retardant composition 46 is extruded from extruder 44 as a strand through strand head 48 to water bath 50. The water in water bath can have a temperature of about 110° F. (43° C.). Flame-retardant composition 46 is directed from water bath 50 to air dryer 52 and then to strand pelletizer 54. The composition is cut into composition pellets 56 which are directed into classifier 58 which allows selection of ranges of pellet sizes. From the pelletizer 58, the composition pellets 56 are directed to funnel 60 where excess dust can be filtered by funnel filter 62. Composition pellets 56 are directed to hopper 64. From hopper 64, composition pellets 56 can be processed into battery casings by suitable molding equipment, not shown, or composition pellets can be packaged by packaging means 66 or stored for later molding.

A method for forming a non-halogen flame retardant polypropylene includes preblending the components. One-half of the total amount of resin, such as polypropylene, is placed in an accurate loss and weigh feeder preblender. Preweighed ingredients other than the resin added to the preblender, one-half of each ingredient to each side of the blender. The preblender is turned on and the resin is mixed for about five minutes. Thereafter, the remainder of the resin is added to the preblender and mixed for about an additional ten minutes to thoroughly mix the resin and flame-retardant system.

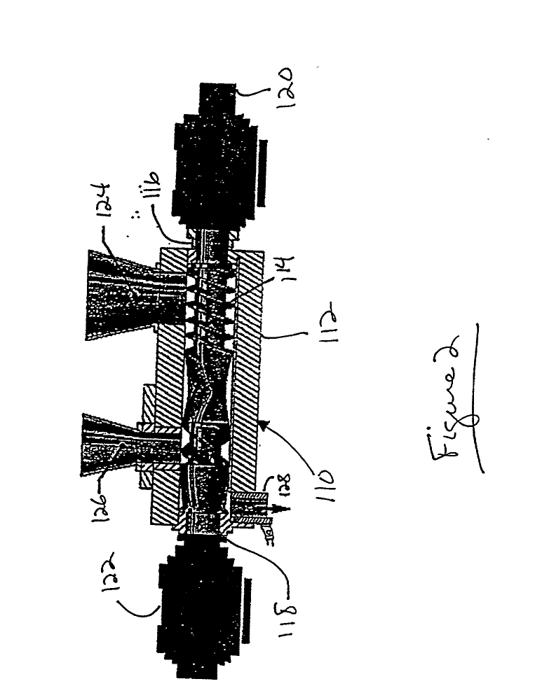

If a continuous mixer is employed for producing the plastic article, a Farrell-type continuous mixer has settings of 500 rpm, 65 amps, a number 11 orifice and a temperature of about 390° F. (199° C.). As shown in one embodiment in FIG. 2, the mixer 110 has housing 112 which includes first rotor 114 and a second rotor (not shown) which is a mirror image of first rotor and is in parallel to the first rotor. First rotor 114 has a first end 116 and a second end 118. First rotor 114 is powered by first motor 120 at first end 116 and second motor 122 at second end 118. Second rotor can also be powered by first motor 120 and second motor 122. In a preferred embodiment, the mixer has two Farrell Style #15 rotors utilizing forward and reverse helix angles that are counterrotating and non-intermeshing. The rotors have a diameter of about 3.84 inches (9.85 cm) (3.95 inches (10.03 cm) nominal) with a working rotor length of about fourteen inches. The rotors are ground down about 0.11 inches from an original diameter of 3.95 inches to a diameter of 3.84 inches in order to provide a clearance between an outer edge of the helix screws and the interior wall of the housing of about 0.11 inches. Due to the high shear of the thermoplastic flame retardant composition, the added space between the wall of the housing and the rotors, the processing is improved while allowing the temperature to remain low. The reduced angle and size on the rotor is to avoid raising temperature which is preferably kept in a range of between about 340° F. (171° C.) and 410° F. (210° C.). In a preferred embodiment, the temperature is about 360° F. (182° C.).

Mixer 110 has means for heating, not shown, to a suitable temperature for melting the thermoplastics, such as to a temperature in the range of between about 350° F. and 450° F. Heating can be provided by, for example, steam or electrical resistance. Housing 112 has a first inlet 124 for receiving the thermoplastics, the fire retardant system and other components for mixing. Housing 112 has second inlet 126 for adding additional components after some mixing and for allowing any released gases to vent. Housing 112 has outlet 128 for removing the mixed thermoplastic fire retardant composition from the mixer.

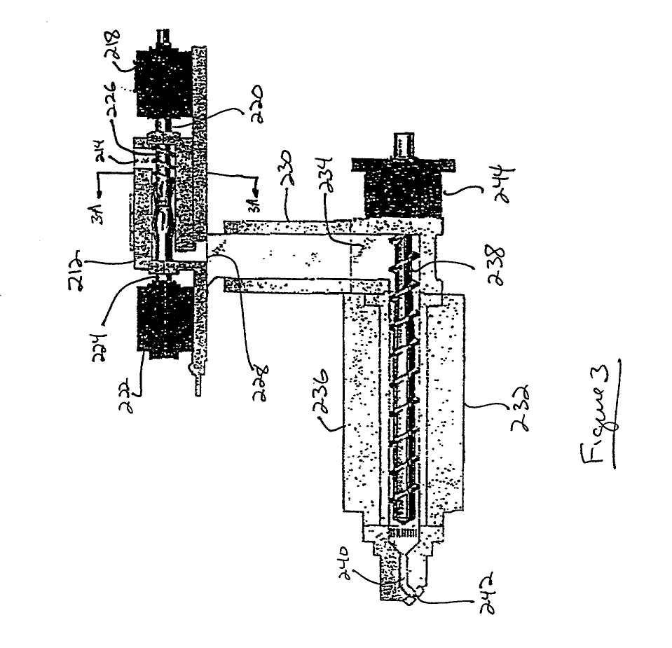

Another embodiment of the mixer is shown in FIG. 3. Mixer 210 has housing 212, which includes first rotor 214 and second rotor 216. Second rotor 216 is not shown in FIG. 3, but is shown in FIG. 3A, which is a cross-sectional view along line 3A. Returning to FIG. 3, first rotor 214 and second rotor 216 are driven by first motor 218 at first end 220 and second motor 222 at second end 224. Housing inlet 226 is for receiving the thermoplastic and flame retardant system. The components can be directed through housing 212 to housing outlet 228.

The mixed composition can be directed from housing outlet 228 through conduit 230 to extruder 232 at extruder inlet 234. Extruder 232 has extruder housing 236. Extruder housing 236 has extruder screw 238 for directing composition from extruder inlet 234 through extruder housing 236 to extruder outlet 246 for extruding the composition through extruder nozzle 242. Extruder screw 238 is driven by extruder motor 244.

Extruder 232 can be set at, for example, about 88 rpm, 16 amps and a temperature in a range of between about 380° F. (193° C.) and about 430° F. (221 ° C.). For battery casings, the requirement includes long term aging for the battery housing thereby requiring a lower temperature than typically employed for the plastic resin. The extruded resin can be cooled by a water bath having a temperature of about 110° F. (43° C.).

The extruder resin system can be pelletized or can conduct other processing as necessary. If pelletizing is done, a pelletizer, such as a pelletizer commercially available from Conair, Inc., is set to about 44 rpm to form pellets which have a diameter in the range of between about 0.03125 and 0.0625 inches (0.079 and 0.16 cm). Hot, dry air is blown over the pellets prior to packaging to minimize water contact and absorption.

The flame-retardant resin can be reheated to a temperature of about 41 0° F. (210° C.) for molding battery casings or other suitable structures. The thickness of a battery casing is in the range of about 0.03125 and 0.125 inches (0.079 and 0.32 cm) and the product is ribbed.

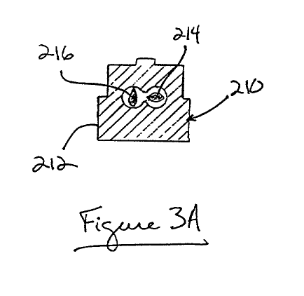

FIG. 4 shows a lower portion of a battery housing or casing formed of the flame-retardant thermoplastic composition. Battery casing 310 has a bottom portion 312, which has a series of six compartments 314 divided by partitions 316 which extend to the bottom of battery casing 310 within outer walls 318 for holding the anode and cathode battery plates. Outer walls 318 have ribs 320 for additional structural strength.

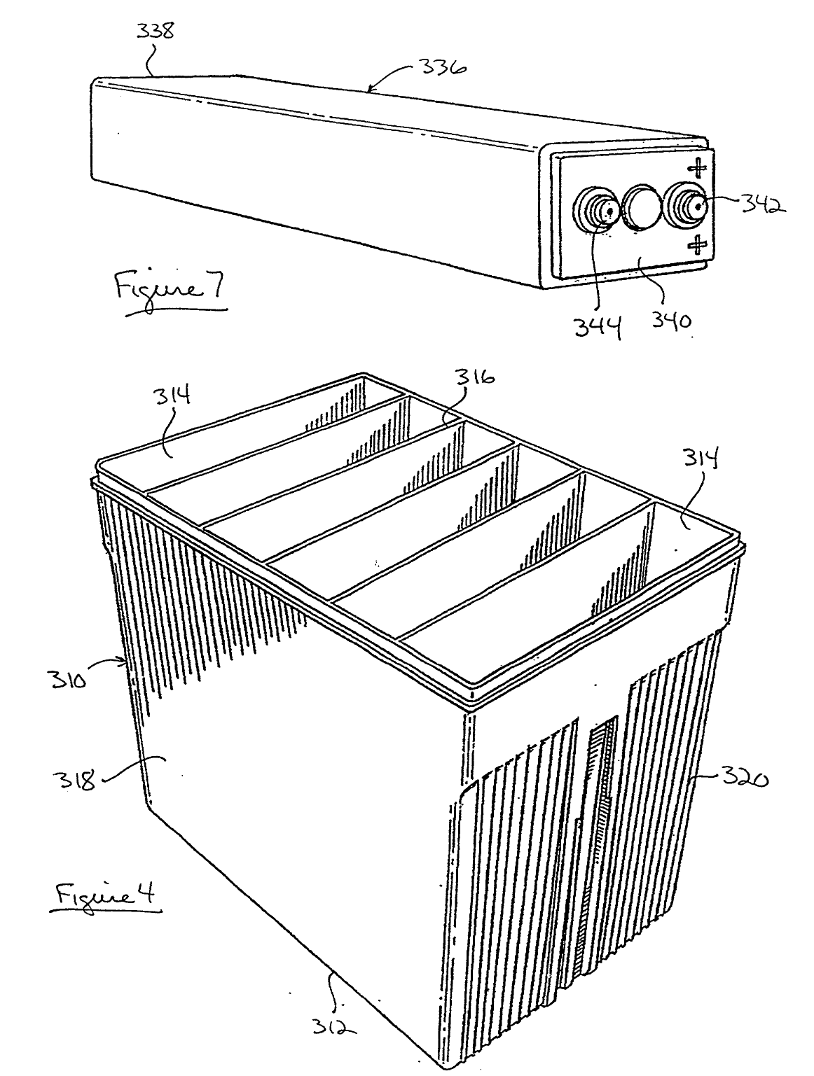

FIG. 5 shows one embodiment of first battery 322 which is a sealed battery. First battery 322 has upper portion 324 that includes cover 326 with positive terminal 328 and negative terminal 330.

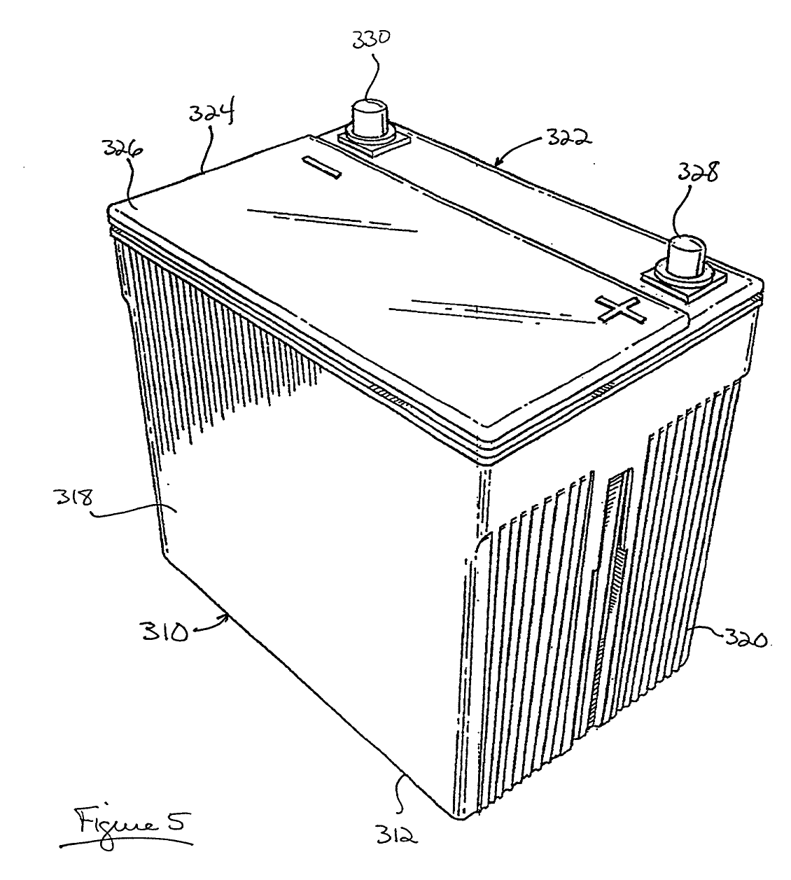

FIG. 6 shows an embodiment of second battery 332 similar to the first battery except second battery 332 has caps 334 that are removable for adding liquid to the battery, such as a solution of sulfuric acid.

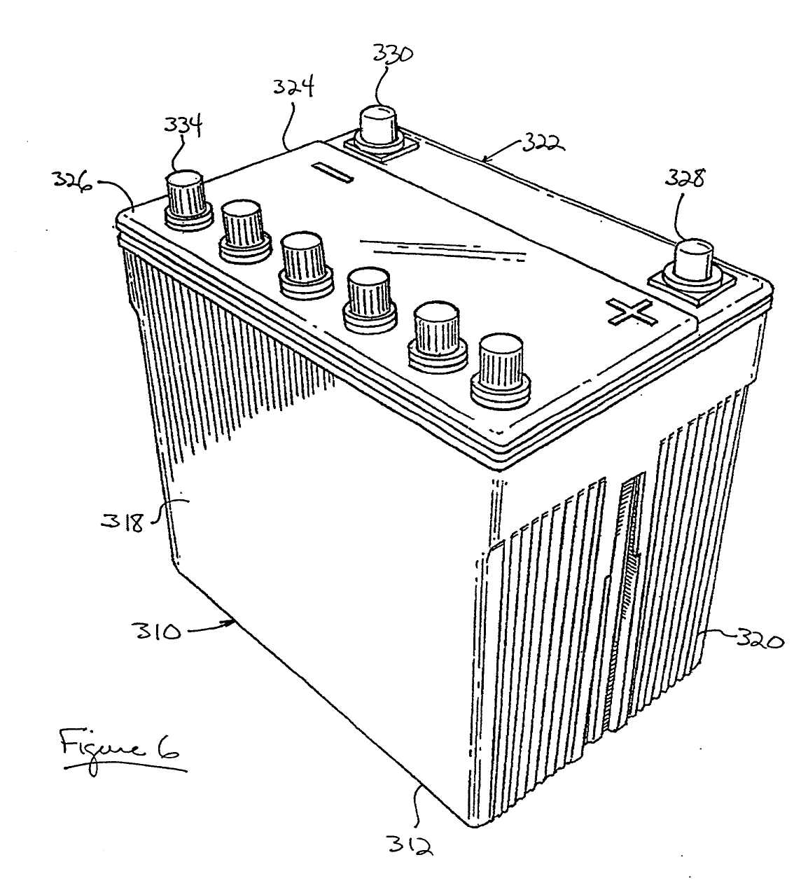

FIG. 7 shows another embodiment of a battery in accordance with the invention. Horizontal battery 336 lays in a horizontal rather than vertical position. Horizontal battery 336 has horizontal casing 338 with terminal end 340 that has positive terminal 342 and negative terminal 344. Horizontal casing 338 is formed of the flame-retardant composition. Horizontal battery 336 can be used as a sealed motive power battery.

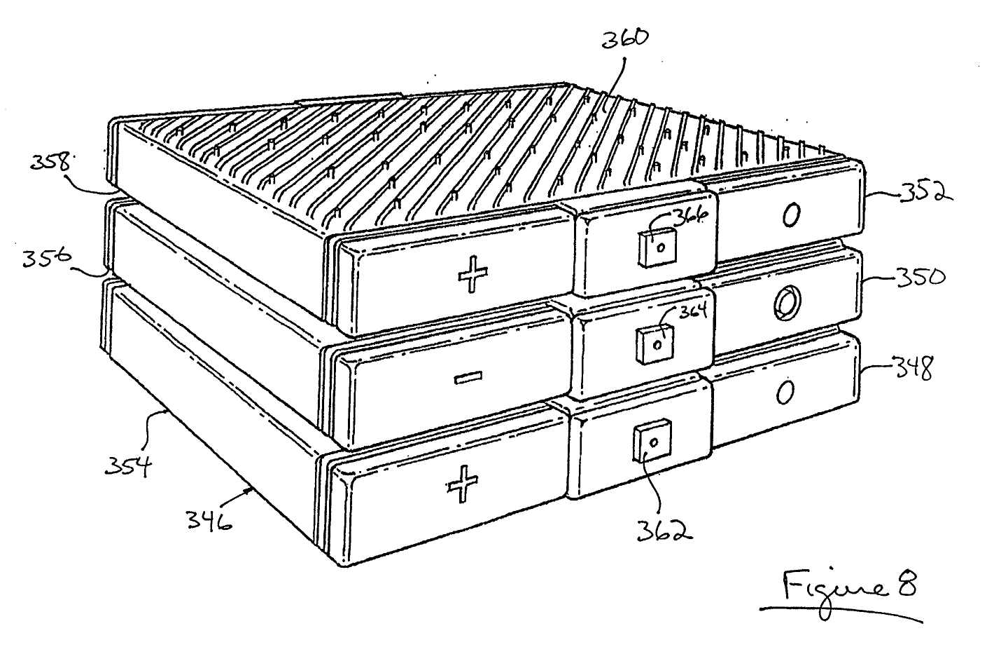

FIG. 8 shows another further embodiment of a battery. Battery unit 346 is an example of an uninterrupted power supply (UPS) battery. In this embodiment, battery unit 346 has first UPS battery 348, second UPS battery 350 and third UPS battery 352. The UPS batteries can be stacked. First UPS battery 348 has first UPS casing 354, second UPS battery 350 has second UPS casing 356, and third UPS battery 352 has third UPS casing 358. As shown on third casing 358, the casing has ribbing 360 for structural strength. Each battery has a positive terminal and negative terminal. First UPS battery 348 has first positive terminal 362 and first negative terminal, not shown, at opposite end of first UPS battery 348. Similarly second positive terminal, not shown, and second negative terminal 364 is on second UPS battery. Third positive terminal 366 and third negative terminal, now shown, is on third UPS battery.

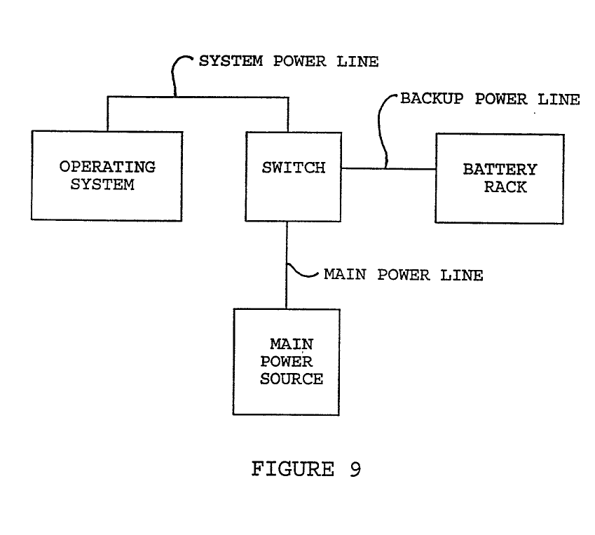

FIG. 9 shows a schematic diagram of a power source for an operating system, such as a computer system. The operating system is connected to a switch by a system power line which directs electrical current to the operating system. Switch is connected to main power source, which can be an outside electrical power source, by main power line. Switch is also connected to a battery rack by backup power line. The battery rack can include batteries formed with casings of the flame- retardant polymer composition. Electrical power can be switched from the main power source to the battery rack automatically if main power is lost, thereby avoid interruption of operation of the operating. Alternatively, the switch can be manually switched from main power line to backup power line.

### EXAMPLES

The polymers used in the examples had a melt flow index (MFI) that was measured as specified under ASTM D-1238.

The flame retardant system for the following examples include:

Example 1: tetrabromobisphenol A bis (2,3-dibromopropyl ether) and antimony trioxide;

Examples 2,5,11,12,13,14: decabromodiphenyl oxide and antimony trioxide;

Example 3: bis(3,4-dibromo,4-dibromo propyloxy phenyl) sulfone and antimony trioxide;

Example 4: ethylene-bis-tetrabromophthalimide and antimony trioxide;

Example 6: ammonium polyphosphate;

Example 7: phosphate salt A;

Example 8: phosphate salt A and coupling agent;

Example 9: phosphate sale B; and

Example 10: phosphate salt B and coupling agent.

Examples 1-5 and 11-14 included halogenated flame retardant systems, and Examples 6-10 included non-halogenated flame retardant systems.

The reinforcement promoter/hydrophobic agent was a zirconate or silane-based coupling agent.

The color concentrate varied depending on the application. Color concentrates used in the examples included gray, light gray, blue, red, white and black compositions.

The antioxidant used in the examples included tetrakismethylene (3,5-di-t-butyl-4-hydroxyphenyl) propionate (Irganox 1010 or equivalent) and/or octadecyl-3-(3′,5′-di-t-butyl-4-hydroxyhydrocinnamate) methane (Irganox 1076 or equivalent); a blend of tetrakismethylene (3,5-di-t-butyl-4-hydroxyphenyl) propionate/tris (2,4-di-t-butyl-phenyl) phosphite/di-stearyl-3,3′-thio-dipropionate (Lowinox TB311); also thermal heat stabilizer (Thermchek 832) and metal deactivator (Irganox 1024).

### Glossary of Materials

Epsilon E-1112™ 12 MFI Polypropylene Homopolymer

Epsilon E-4121™ 12 MFI Polypropylene Copolymer

Great Lakes PE-68™ [tetrabromobisphenol A bis (2,3-dibromopropyl

ether)] Brominated Flame Retardant

Non Nen™ 52 [bis(3,4-dibromo,4-dibromo propyloxy phenyl) sulfone]

Brominated Flame Retardant

Great Lakes DE-83R™ [decabromodiphenyl oxide] Brominated Flame

Retardant

Saytex™ BT-93 or BT-93(W)

[ethylenebistetrabromophthalimide]Brominated Flame Retardant

Sb₂O₃ [antimony oxide] Halogen Synergist

Hostaflam™ AP750 [ammonium polyphosphate] Non-halogen Flame

Retardant

MP [melamine phosphate] Intumescent Additive

Amgard™NK Intumescent Phosphate Salt Flame Retardant

Amgard™NP [ethylene diamine phosphate salt] Intumescent Phosphate

Salt Flame Retardant

Kenrich NZ 12™ Zirconate Based Coupling Agent

Union Carbide A-174™ Silane Based Coupling Agent

Kemamide™E and/or W40 Amide Lubricants

Color Concentrates of Red, White Black, Gray, Blue

Carbon Black Colorant

Thermchek™ 832 Tin-based Thermal Stabilizer

Irganox™ 1010 Antioxidant

Irganox™ 2076 Antioxidant

Lowinox™ TB311 Antioxidant Blend

Hostanox™ 03 Antioxidant

Hostanox™ PAR 24 Antioxidant

Irganox™ 1024 Metal Deactivator

CaCO₃ Calcium Carbonate Filler

Translink™ 37 Clay Filler

### Examples 1-5

The following information describes a general preparation for compositions useful in the invention. Examples 1-5 differ in the halogenated flame retardant system used and the level of said systems in polypropylene mixtures. The values for the components of Examples 1-5, as shown in Table 1, are in parts by weight.

TABLE 1

| | Ex 1 | Ex 2 | Ex 3 | Ex 4 | Ex 5 |
|---|---|---|---|---|---|
| E-1112 | 50.0 | 50.0 | 50.0 | 50.0 | 50.0 |
| E-4212 | 50.0 | 50.0 | 50.0 | 50.0 | 50.0 |
| PE-68 ™ | 10.0 | | | | |
| DE-83R ™ | | 25.0 | | 13.0 | 11.0 |
| Non Nen ™ 52 | | | 10.0 | | |
| BT-93 ™/BT- | | | | 12.0 | |
| 93(W) | | | | | |
| Sb₂O₃ | 3.0 | 8.0 | 3.0 | 8.0 | 3.0 |
| Kemamide ™ E | 0.1 | 0.3 | 0.1 | 0.3 | 0.4 |
| or W40 | | | | | |
| Color | 1.0 | 1.0 | 1.0 | 1.0 | 1.0 |
| Concentrate | | | | | |
| Thermchek ™ | 0.3 | 0.5 | 0.3 | 1.0 | 1.0 |
| 832 | | | | | |
| Irganox ™ | 0.3 | 0.3 | 0.3 | 0.3 | 0.3 |
| 1010 | | | | | |
| Irganox ™ | 0.2 | 0.2 | 0.2 | 0.2 | 0.2 |
| 1024 | | | | | |

Formulations 1-5 were charged into a Farrell Continuous Mixer (FCM) CP-34, Banbury 3D, FCM 6/8 and twin-screw extruder. To prevent classification of materials of differing physical forms in the FCMs, the pellet-based materials were charged first. Powdered materials were pre-mixed in a high-shear mixer to ensure proper product distribution. The pre-mixed powders were then charged to the low shear mixer of the FCM; blending of the powder/pellet mix was discontinued to prevent powder settling once the powders were thoroughly dispersed. The compositions were processed at 350° F. in the FCM and Banbury and at 375° F. in the extruder. Resultant materials were recovered and molded into test specimens as set forth under ASTM test methods using a 30-ton Boy Injection Molding Machine with a polymer melt temperature of 415° F. The mechanical properties of the molded samples were tested in accordance with ASTM test methods. The flammability ratings of the molded parts were determined in accordance with Underwriter's Laboratory Standard UL-94. The results are summarized in Table 2.

TABLE 2

| Property | Test | Units | Ex 1 | Ex 2 | Ex 3 | Ex 4 | Ex 5 |
|---|---|---|---|---|---|---|---|
| Specific | ASTM | | 0.97 | 0.98 | 0.97 | 1.02 | 0.95 |
| Gravity | D1505 | | | | | | |
| Melt Flow | ASTM | g/10 | 15.0 | 15.0 | 15.0 | 9.6 | 15.0 |
| Rate | D1238 | min | | | | | |
| Tensile | ASTM | psi | 3750 | 2850 | 3800 | 2500 | 4200 |
| Strength | D638 | | | | | | |
| Yield | ASTM | psi | 3550 | 1760 | 3550 | 3000 | 4200 |
| Strength | D638 | | | | | | |
| Elonga-tion | ASTM | % | 400 | 150 | 325 | 40 | 150 |
| | D638 | | | | | | |
| Burn | UL-94 | | V-0 | V-0 | V-0 | V-0 | V-2 |
| Rating | | | | | | | |
| 1/32″-1/8″ | | | | | | | |
| Oxygen | ASTM | % | 31.0 | 28.0 | 31.0 | 29.0 | 25.0 |
| Index | D2863 | | | | | | |
| Gardner | ASTM | ft-lb/ | 15.0 | 8.0 | 15.0 | 15.0 | 15.0 |
| Impact | D3029 | in. | | | | | |
| Izod | ASTM | ft-lb | 1.3 | 0.8 | 1.3 | 0.9 | 0.65 |
| Impact, | D256 | | | | | | |
| notched | | | | | | | |
| Flexural | ASTM | psi | 255,000 | 300,000 | 250,000 | 263,000 | 300,000 |
| Modulus | D790 | | | | | | |
| Specific | ASTM | | 0.97 | 0.98 | 0.97 | 1.02 | 0.95 |
| Gravity | D1505 | | | | | | |
| Melt Flow | ASTM | g/10 | 15.0 | 15.0 | 15.0 | 9.6 | 15.0 |
| Rate | D1238 | min | | | | | |
| Tensile | ASTM | psi | 3750 | 2850 | 3800 | 2500 | 4200 |
| Strength | D638 | | | | | | |
| Yield | ASTM | psi | 3550 | 1760 | 3550 | 3000 | 4200 |
| Strength | D638 | | | | | | |
| Elonga-tion | ASTM | % | 400 | 150 | 325 | 40 | 150 |
| | D638 | | | | | | |
| Burn | UL-94 | | V-0 | V-0 | V-0 | V-0 | V-2 |
| Rating | | | | | | | |
| 1/32″-1/8″ | | | | | | | |
| Dielectric | ASTM | | 2.11 | 2.24 | 2.13 | 2.40 | 2.40 |
| Constant | D1531 | | | | | | |
| (1 kHz), | | | | | | | |
| 23° C. | | | | | | | |

The resultant compositions possessed the following properties: low smoke, flame retardant, good mechanical properties, good electrical properties, excellent processability, excellent heat seal properties, excellent weld impact properties, and minimal moisture absorption.

### Examples 6-10

The following information describes a general preparation for compositions useful in the invention. Examples 6-10 differ in the non-halogen flame retardant system and coupling agents used in polypropylene mixtures. The values for the components of Examples 6-10, as shown in Table 3, are in parts by weight.

TABLE 3

| | Ex 6 | Ex 7 | Ex 8 | Ex 9 | Ex 10 |
|---|---|---|---|---|---|
| E-1112 | 51.0 | 50.0 | 50.0 | 50.0 | 50.0 |
| E-4212 | 49.0 | 50.0 | 50.0 | 50.0 | 50.0 |
| Hostaflam ™ | 40 | | | | |
| AP-750 | | | | | |
| Amgard ™ NK | | 35.0 | 35.0 | | |
| Amgard ™ NP | | | | 40.0 | 32.0 |
| MP | | | | | 8.0 |
| NZ12 ™ | | | 0.25 | | |
| A-174 ™ | | | | 0.25 | 0.25 |
| Color Concentrate | 1.0 | 1.0 | 1.0 | 1.0 | 1.0 |
| Lowinox ™ | | 0.3 | 0.3 | 0.3 | 0.3 |
| TB311 | | | | | |
| Irganox ™ 1024 | | 0.2 | 0.2 | 0.2 | 0.2 |
| Hostanox ™ 03 | 0.35 | | | | |
| Hostanox ™ | 0.35 | | | | |
| PAR24 | | | | | |

Formulations 6-10 were charged into a Farrel Continuous Mixer (FCM) CP-45, Banbury 3D, FCM 6/8 and twin-screw extruder. To prevent classification of materials of differing physical form in the FCMs, the pellet-based materials were charged first. Powdered materials were pre-mixed in the low shear mixer of the FCM; blending of the powder/pellet mix was discontinued to prevent powder settling once the powders were thoroughly dispersed. The compositions were processed at 350° F. in the FCM and Banbury and at 375° F. in the extruder. Resultant materials were recovered and molded into test specimens as set forth under ASTM test methods using a 30-ton Boy Injection Molding Machine with a polymer melt temperature of 425° F. The mechanical properties of the molded samples were tested in accordance with ASTM test methods. The flammability ratings of the molded parts were determined in accordance with Underwriter's Laboratory Standard UL-94. The results are summarized in Table 4.

TABLE 4

| Property | Test | Units | Ex 1 | Ex 2 | Ex 3 | Ex 4 | Ex 5 |
|---|---|---|---|---|---|---|---|
| Specific | ASTM | | 1.04 | 1.02 | 1.02 | 1.02 | 1.02 |
| Gravity | D1505 | | | | | | |
| Melt Flow | ASTM | g/10 | 15.0 | 9.6 | 12.0 | 16.0 | 15.0 |
| Rate | D1238 | min | | | | | |
| Tensile | ASTM | psi | 2840 | 2500 | 2300 | 2700 | 2400 |
| Strength | D638 | | | | | | |
| Yield | ASTM | psi | 2840 | 3000 | 2600 | 3200 | 2900 |
| Strength | D638 | | | | | | |
| Elonga- | ASTM | % | 200 | 40 | 150 | 90 | 80 |
| tion | | | | | | | |
| Burn | UL-94 | | V-0 | V-0 | V-0 | V-0 | V-0 |
| Rating | | | | | | | |
| 1/32″-1/8″ | | | | | | | |
| Oxygen | ASTM | % | 29.0 | 29.0 | 29.0 | 28.0 | 29.0 |
| Index | D2863 | | | | | | |
| Gardner | ASTM | ft- | 12.0 | 15.0 | 15.0 | 14.0 | 16.0 |
| Impact | D3029 | lb/ | | | | | |
| | | in. | | | | | |
| Izod | ASTM | ft-lb | 1.1 | 0.9 | 0.8 | 0.7 | 0.9 |
| Impact, | D256 | | | | | | |
| notched | | | | | | | |
| Flexural | ASTM | psi | 228,000 | 263,000 | 275,000 | 260,000 | 270,000 |
| Modulus | 790 | | | | | | |
| Dielectric | ASTM | | 12.45 | 2.40 | 2.38 | 2.42 | 2.48 |
| Constant | D1531 | | | | | | |
| (1 kHz), | | | | | | | |
| 23 C. | | | | | | | |

The resultant compositions possessed the following properties: non-hazardous gases, low smoke, flame retardant, good mechanical properties, good electrical properties, excellent processability, excellent heat seal properties, excellent weld impact properties, and minimal moisture absorption.

### Examples 11-14

The following information describes a general preparation for compositions useful in the invention. examples 11-14 differ in the polymer type, halogenated flame retardant levels and filler type used in polypropylene mixtures. The values for the components of Examples 11-14, as shown in Table 5, are in parts by weight.

TABLE 5

| | Ex 11 | Ex 12 | Ex 13 | Ex 14 |
|---|---|---|---|---|
| E-1112 | | 100.0 | | |
| E-4212 | 100.0 | | 100.0 | 100.0 |
| DE-83R ™ | 22.0 | 22.0 | 25.0 | 25.0 |
| Sb₂O₃ | 5.0 | 5.0 | 8.2 | 8.2 |
| CaCO₃ | | | 27.2 | |
| Translink ™ 37 | | | | 30.0 |
| Kemamide ™ E or W40 | 0.7 | 0.7 | 0.8 | 0.08 |
| Color Concentrate | 1.0 | 1.0 | 1.0 | 1.0 |
| Thermchek ™ 832 | 1.6 | 1.1 | 1.5 | 1.5 |
| Irganox ™ 1010 | 0.5 | 0.5 | 1.6 | 1.6 |
| Irganox ™ 1024 | 0.2 | 0.2 | 0.2 | 0.2 |

Formulations 11-14 were charged into a Farrel Continuous Mixer (FCM) CP-45, Banbury 3D, FCM 6/8 and twin-screw extruder. To prevent classification of materials of differing physical form in the FCMs, the pellet-based materials were charged first. Powdered materials were pre-mixed in a high-shear mixture to ensure proper product distribution. The pre-mixed powders were then charged to the low shear mixer of the FCM; blending of the powder/pellet mix was discontinued to prevent powder settling once the powders were thoroughly dispersed. The compositions were processed at 350° F. in the FCM and Banbury and at 375° F. in the extruder. Resultant materials were recovered and molded into test specimens as set forth under ASTM test methods using a 30-ton Boy Injection Molding Machine with a polymer melt temperature of 415° F. The mechanical properties of the molded samples were tested in accordance with ASTM test methods. The flammability ratings of the molded parts were determined in accordance with Underwriter's Laboratory Standard UL-94. The results are summarized in Table 6 below.

TABLE 6

| Property | Test | Units | Ex 11 | Ex 12 | Ex 13 | Ex 14 |
|---|---|---|---|---|---|---|
| Specific | ASTM | | 1.00 | 1.00 | 1.12 | 1.12 |
| Gravity | D1505 | | | | | |
| Melt Flow | ASTM | g/10 | 15.0 | 15.0 | 17.0 | 16.0 |
| Rate | D1238 | min | | | | |
| Tensile | ASTM | psi | 2600 | 4100 | 2500 | 2650 |
| Strength | D638 | | | | | |
| Yield | ASTM | psi | 2600 | 4100 | 2500 | 2700 |
| Strength | D638 | | | | | |
| Elonga-tion | ASTM | % | 400 | 5 | 100 | 125 |
| | D638 | | | | | |
| Burn | UL-94 | | V-0 | V-0 | V-0 | V-0 |
| Rating | | | | | | |
| 1/32″-1/8″ | | | | | | |
| Oxygen | ASTM | % | 31.0 | 32.0 | 29.0 | 29.0 |
| Index | D2863 | | | | | |
| Gardner | ASTM | ft-lb/ | 20.0 | 3.0 | 13.0 | 12.0 |
| Impact | D3029 | in. | | | | |
| Izod | ASTM | ft-lb | 1.5 | 0.1 | 0.65 | 0.70 |
| Impact, | D256 | | | | | |
| notched | | | | | | |
| Flexural | ASTM | psi | 175,000 | 375,000 | 300,000 | 300,000 |
| Modulus | D790 | | | | | |
| Dielectric | ASTM | | 2.40 | 2.40 | 2.70 | 2.65 |
| Constant | D1531 | | | | | |
| (1 kHz), | | | | | | |
| 23° C. | | | | | | |

The resultant compositions possessed the following properties: low smoke, flame retardant, good mechanical properties, good electrical properties, excellent processability, excellent heat seal properties, excellent weld impact properties, and minimal moisture absorption. Equivalents

Those skilled in the art will recognize, or be able to ascertain using no more than routine experimentation, many equivalents to specific embodiments of the invention described specifically herein. Such equivalents are intended to be encompassed in the scope of the following claims.

What is claimed:

1. (Amended) A battery casing comprising:
a) a bottom portion having a bottom and side walls forming a compartment for holding a battery acid and battery plates;
b) top portion for covering said compartment, wherein the bottom portion and top portion are formed of a flame retardant thermoplastic composition comprising a homopolymer, a copolymer, and ammonium polyphosphate, the battery casing having a bum rating of V-O under the UL-94 standard and a flexural modulus in the range of 228,000 to 275,000.

2. (Amended) A battery casing formed of a flame-retardant thermoplastic composition, comprising:
a) a homopolymer
b) a copolymer; and
c) ammonium polyphosphate, the battery casing having a bum rating of V-O under the UL-94 standard and a flexural modulus in the range of 228,000 to 275,000.

3. The battery casing of claim 2 wherein the homopolymer includes Polypropylene.

4. The battery casing of claim 2 wherein the homopolymer includes polyethylene.

5. The battery casing of claim 2 wherein the copolymer includes ethylene and propylene.

6. The battery casing of claim 2 wherein the homopolymer of the composition is in a range of between about 33 and 35 percent by weight.

7. The battery casing claim 2 wherein the copolymer of the composition is in a range of between about 33 and 35 percent by weight.

8. (Amended) The battery casing of claim 2 wherein the ammonium polyphosphate comprises a flame-retardant system having a melt flow rate in the range of 12.0 to 16.0 g/10 min.

9. The battery casing of claim 2 wherein the ammonium polyphosphate is in the range of between about 25 and 27 by weight.

10. The battery casing claim 2 wherein the homopolymer and copolymer are selected from polyolefins.

11. (Amended) the battery casing of claim 2 wherein the homopolymer and copolymer comprise a crystalline product formed by polymerization of one or more monoolefins selected from the group consisting of ethylene, propylene, 1-butene, 1-pentene, 1-hexene, 2-methyl-1-propene, 3-methyl-1-pentene, 4-methyl-1penetene, and 5-methyl-1-hexene.

12. The battery casing of claim 11 wherein monoolefins are selected from the group consisting of proplylene and ethylene.

13. The battery casing of claim 12 wherein the polymerized polypropylene is selected from the group consisting of isotatic polymers of propylene, ethylene, and copolymers of propylene with ethylene.

14. The battery casing of claim 2 wherein the thermoplastic composition, also includes a filler selected from the group consisting of aluminum trihydrate, hydrated magnesium, hydrated calcium silicate and calcium carbonate.

15. The battery casing of claim 14 wherein said filler varies from about 0-250 parts per 100 parts of the homopolymer and copolymer.

16. The battery casing of claim 14 wherein said filler further includes melamine and polyol.

17. The battery casing of claim 2 which is included in a photovoltaic battery.

18. The battery casing of claim 2 which is included in a motive battery.

19. The battery casing of claim 2 which is included in a backup battery.

20. (Amended) A method for forming a flame-retardant composition for a battery casing comprising blending a homopolymer, copolymer and ammonium polyphosphate together at a temperature in a range of between about 340 and 410° F. to form the flame retardant composition, the composition having a melt flow rate in the range of 9.6 to 16.0 g/10 min. and flexural modulus in the range of 228,000 to 275,000.

21. The method of claim 20 wherein the composition is blended with two rotors having forward and reverse helix angles and said rotors are counterrotating and non-intermeshing.

22. The method of claim 21 wherein the rotors have a diameter of about 3.84 inches and working length of about fourteen inches.
